(19) United States
(12) Patent Application Publication
(10) Pub. No.: US 2013/0219311 A1
(43) Pub. Date: Aug. 22, 2013

(54) DISPLAYING ASSOCIATION INFORMATION OF MULTIPLE GRAPHIC OBJECTS IN A GRAPHICAL USER INTERFACE

(71) Applicants: Jeffrey A. Calcaterra, Chapel Hill, NC (US); Renier R. Morales, Camino Miram, PR (US)

(72) Inventors: Jeffrey A. Calcaterra, Chapel Hill, NC (US); Renier R. Morales, Camino Miram, PR (US)

(73) Assignee: INTERNATIONAL BUSINESS MACHINES CORPORATION, Armonk, NY (US)

(21) Appl. No.: 13/400,402

(22) Filed: Feb. 20, 2012

(51) Int. Cl. G06F 3/048

(52) U.S. Cl. 715/765

(57) ABSTRACT

A first graphic object and a second graphic object are displayed within a graphic user interface (GUI). There may be at least one association that governs both the first graphic object and the second graphic object. For instance, a particular association may indicate that the second graphic object may only be manipulated by the user if the first graphic object has previously been manipulated by the user. A third graphic object may be displayed within the GUI. The third graphic object may be a notification graphic object and may also be displayed. The user may manipulate the third graphic object causing information related to the association be displayed within the GUI. The user's experience may be enhanced because greater information is made available to the user. For example, information may be displayed instructing the user to make corrective actions.

### FIELD OF THE INVENTION

Embodiments of present invention generally relate to the field of software and in particular to providing a graphical user interface (GUI). More specifically, embodiments of the present invention relate to displaying association information of multiple graphic objects within a GUI.

### DESCRIPTION OF THE RELATED ART

A GUI is an image based interface that allows users to interact with electronic devices. The use of GUIs is widespread. For example, GUIs are used in computers, tablet computers, mobile phones, portable media players, gaming devices, household appliances, cash machines, and office equipment. A GUI may visually represent actions available to a user for interaction with an electronic device. The actions may be performed through manipulation of graphical objects within the GUI.

### SUMMARY

In various embodiments, a first graphic object and a second graphic object are displayed within a graphic user interface (GUI). There may be at least one association that governs both the first graphic object and the second graphic object. For instance, a particular association may indicate that the second graphic object may only be manipulated by the user if the first graphic object has previously been manipulated by the user. A third graphic object may be displayed within the GUI. The third graphic object may be a notification graphic object and may also be displayed within the GUI. The user may manipulate the third graphic object causing information related to the association be displayed within the GUI. The user's experience may be enhanced because greater information is made available to the user. For example, information may be displayed instructing the user to make corrective actions.

In certain embodiments, the first graphic object and the second graphic object are allowed to be displayed within the GUI of a computer system. Upon receiving a user manipulation of the first graphic object, the third graphic object is also allowed to be displayed within the GUI. The third graphic object may be displayed in connection with the first graphic object and/or the second graphic object. Finally, information related to the at least one association is allowed to be displayed within the GUI in connection with either the first, second, and/or third graphic object. In various embodiments, the information related to the at least one association may be displayed within a message box in the GUI.

In certain embodiments, the information related to the at least one association governing both the first graphic object and the second graphic object is displayed prior to the computer system receiving an action manipulation. For example, corrective action information is displayed prior to a user manipulating a ‘start’ or ‘end’ graphic object. In various embodiments, the information related to the at least one association identifies one or more user manipulations that can not be jointly completed for the first graphic object and for the second graphic object.

In certain embodiments, the third graphic object is allowed to be displayed subsequent to receiving a user manipulation of the second graphic object. When the first graphic object and the second graphic object are manipulated the one or more associations that govern both the first graphic object and the second graphic object may be determined.

In various embodiments, the third graphic object is a notification graphic object that includes an icon indicative of the at least one association governing both the first graphic object and the second graphic object.

In another embodiment, a computer program product for providing a GUI is described. The computer program product includes a computer readable storage medium; first program instructions to allow, using a processor, the first graphic object and the second graphic object be displayed within the GUI; second program instructions to allow, using a processor, the third graphic object be displayed within the GUI; and third program instructions to allow, using a processor, information related to the at least one association governing both the first graphic object and the second graphic object be displayed within the GUI.

In certain embodiments, the computer program product also include fourth program instructions for determining, using a processor, the at least one association governing both the first graphic object and the second graphic object, upon receiving the user manipulation of the first graphic object and the user manipulation of the second graphic object.

In certain embodiments, the first, second, third, and/or fourth program instructions are stored on the computer readable storage medium.

In some embodiments, the second program instructions allow the third graphic object be displayed within the GUI subsequent to also receiving a user manipulation of the second graphic object and/or the third program instructions allow the at least one association governing both the first graphic object and the second graphic object be displayed within a message box.

In yet another embodiment a computer system includes: a display device; a graphic object manipulation receiver; a processor programmed to provide a GUI upon the display device; wherein the GUI is operative to at least: allow the first graphic object and the second graphic object be displayed upon the display device; allow the third graphic object be displayed upon the display device; and allow information related to the at least one association governing both the first graphic object and the second graphic object be displayed upon the display device.

In certain embodiments, the GUI is further operative to allow the third graphic object be displayed upon the display device subsequent to also receiving a user manipulation of the second graphic object via the graphic object manipulation receiver.

### BRIEF DESCRIPTION OF THE DRAWINGS

FIG. 1 illustrates components and an interconnection topology for an information handling system that may utilize or enable one or more embodiments the present invention.

FIG. 2 and FIG. 3 illustrate exemplary GUIs according to embodiments of the present invention.

FIG. 4 illustrates an exemplary GUI including associations governing various graphic objects, according to embodiments of the present invention.

FIG. 5 illustrates an exemplary GUI including notification graphic objects, according to embodiments of the present invention.

FIG. 6 illustrates an exemplary GUI including notification graphic objects and message boxes, according to embodiments of the present invention.

FIG. 7A illustrates exemplary user manipulations within an exemplary GUI, according to embodiments of the present invention.

FIG. 7B illustrates exemplary associations governing various graphic objects, according to embodiments of the present invention.

FIG. 8 illustrates exemplary user manipulations within an exemplary GUI capable of displaying associations, according to embodiments of the present invention.

FIG. 9 illustrates exemplary user manipulations within an exemplary GUI that may display associations and other visual indications, according to embodiments of the present invention.

FIG. 10-FIG. 13 illustrate exemplary methods according to embodiments of the present invention.

### DETAILED DESCRIPTION

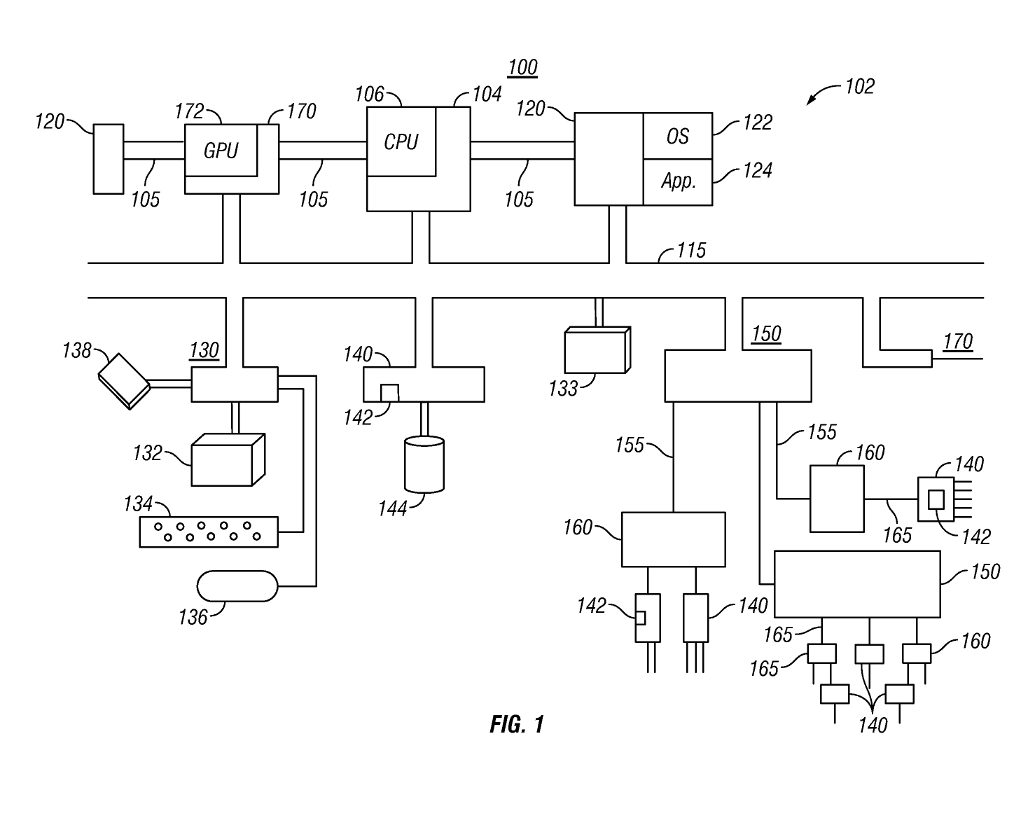

FIG. 1 illustrates components and an interconnection topology for an information handling system, for example a computer system 100 that may utilize or enable one or more embodiments the present invention. Computer system 100 may comprise a host 102 having a host processor complex 104 connected to a memory 120 by an internal bus 105 and/or a host system bus 115. In certain embodiments, host 102 may also include a graphics processor complex 170 connected to memory 120 by an internal bus 105 and/or a host system bus 115. In certain embodiments, graphics processor complex 170 may be included in or may be distinct from host processor complex 104.

The host processor complex 104 has at least one general-purpose programmable processor unit (CPU) 106 that may execute program instructions stored in main memory 120. Although a single CPU 106 is shown in FIG. 1, it should be understood that a processor complex 104 may have multiple CPUs 106. Graphics processor complex 170 has at least one general-purpose programmable graphics processor unit (GPU) 172 that builds images for output to a display 132. CPU 106 working in conjunction with applications 124 sends information about an image to GPU 172. GPU 172 determines how to manipulate pixels on external display 132 or touch screen 133 to create the image. Ultimately, GPU 172 communicates that information to external display 132 or touch screen 133 and the image is displayed to a user.

Memory 120 or a portion of memory 120 may be included within the host processor complex 104 and/or graphics processor complex 170 or connected to it via an internal bus system 105 or via a host system bus 115. Memory 120 may be for example a random access memory for storing data and/or program instructions. Though memory 120 is shown conceptually as a single monolithic entity, memory 120 may be arranged as a hierarchy of caches and other memory devices. In some instances, a hierarchy of cache memories is associated with each CPU 106 and/or GPU 172. Memory 120 includes operating system (OS) 122 and applications 124. Operating system 122 may provide functions such as device drivers or interfaces, management of memory pages, management of multiple tasks, etc., as is known in the art. Applications 124 may be programs, procedures, algorithms, instructions, software, etc. that directs what tasks computer system 100 should accomplish and instructs how computer system 100 should accomplish those tasks. Applications 124 may for example include a server software application whereby a network interface 170 may interact with the server software application to enable computer system 100 to be a network server.

Host system bus 115 may support the transfer of data, commands, and other information between the host processor system 102 and other internal, peripheral, or external devices attached to it. Host system bus 115 may also support the communication of data between external devices independent of the host processor complex 102. While shown in simplified form as a single bus, the host system bus 115 may be structured as multiple buses which may be for example hierarchically arranged. Host system bus 115 may be connected to other internal host 102 components (such as a touch screen display 133, display 132, touch pad, etc.) and/or to a myriad of external or peripheral devices through a connection hub 130, through an adapter 140, a multifunction adapter 150, or directly to a network 170.

In various embodiments discussed herein a user is able to control computer system 100 by making various manipulations in association with a GUI. Therefore, in various embodiments generally, computer system 100 includes a user manipulation receiver that receives such manipulations. For example, in various embodiments a user manipulation receiver may be touch screen display 133, keyboard 134, a mouse or other handheld device 136, etc.

Various devices may be included within computer system 100 and/or connected to computer system 100. These devices may include a monitor or display 132, a keyboard 134, a mouse or other handheld device 136, and/or a printer 138. Display 132 may be a cathode-ray tube display, a flat panel display, or other display technology. One or more adapters 140 may support keyboard 134 and mouse 136; it being understood that other forms of input devices could be used. The number and types of devices shown in FIG. 1 are illustrative only and ordinary users of computer systems now know that a great variety of connected devices exist; e.g., microphones, speakers, infrared remote controls, wireless connected devices, etc. and therefore computer system 100 is not limited to those devices illustrated in FIG. 1.

The host system bus 115 may also be connected to an adapter 140. Adapter 140 is an expansion device that may expand the functionalities of computer system 100. For example, adapter 140 may be an input output (I/O) adapter connected to an external memory device 144, a graphics adapter including graphics processing complex 170 that is connected to an external display 132, etc. External memory device 144 may be rotating magnetic disk storage, rotating or static optical drives, magnetic tape storage, FLASH memory, etc. Adapter 140 may include adapter microcode or firmware and decision logic which may be embodied as a message processor 142. The adapter 140 may also be provided with at least one fast nonvolatile write cache, queues, interrupt registers connected to the message processor 142 and/or decision logic. The message processor 142 may process incoming messages from the host processor complex 102 and generate and transmit response messages back to the host processor complex 102.

An adapter 140 may contain electronic components and logic to adapt or convert data of one protocol on one bus to another protocol on another bus. Therefore, adapters 140 may connect a wide variety of devices to the host computer system 102 and to each other such as, but not limited to, tape drives, optical drives, printers, disk controllers, other bus adapters, PCI adapters, workstations using one or more protocols including, but not limited to, Token Ring, Gigabyte Ethernet, Ethernet, Fibre Channel, SSA, Fiber Channel Arbitrated Loop (FCAL), Serial SCSI, Ultra3 SCSI, Infiniband, FDDI, ATM, 1394, ESCON, wireless relays, Twinax, LAN connections, WAN connections, high performance graphics, etc.

The host system bus 115 may also be connected to a multifunction adapter 150 to which more I/O devices may be connected either directly, or through one or more bridge devices 160, or through another multifunction adapter 150 on either a primary bus 155 or a secondary bus 165. Various components may be connected to the primary bus 155 including, for example, an adapter 140, a bridge device 160, or another multifunction I/O processor or a multifunction adapter 150. The bridge device 160 bridges the primary bus 155 and a secondary bus 165 to which various adapters 140 may be connected. The adapters 140, the primary bus 155, and the secondary bus 165 may conform to the PCI/PCI-X or other industry bus specification. One skilled in the art realizes, however, that the implementation is not limited to a PCI/PCI-X or a SCSI or USB bus implementation but is applicable to any electrical, optical, or wireless bus where data must be efficiently transferred.

Network interface 170 provides an operative connection for transmission of data to and from a network. The network may be an internet but could also be any smaller self-contained network such as an intranet, a WAN, a LAN, or other internal or external network using; e.g., telephone transmission lines, cable services, satellites, fiber optics, T1 lines, wireless, etc., and any other various technologies.

Computer system 100 need not be a computer at all, but may be a simpler device such as a network terminal, a thin client, a terminal-like device, a voice response unit, etc. The convergence of computing, telecommunications and consumer electronics is causing a tremendous growth in the number and variety of pervasive mobile devices as clients. This mobile architecture enables the multitude of client devices including laptops, sub-notebooks, handheld computers such as personal digital assistants and companion devices, and mobile appliances such as smart phones, pagers, simple messaging devices and wearable devices. Thus when the computer system 100 is a mobile device, the adapters 140 and network interfaces 170 support a variety of multi-modal interfaces including traditional keyboard and mouse interfaces, small text screens, pen, touch screens, speech recognition, text-to-speech, and/or wearable devices.

Therefore, in certain embodiments some or all of the devices shown and described in FIG. 1 may be included in a discrete computer system 100 (e.g. touch screen display 133, memory device 144, etc. are included within computer system 100, etc.). In other embodiments some of the devices shown and described in FIG. 1 may be separate, peripheral, or external to computer system 100 (e.g. multiple modular computer systems 100 may share a single large database, external display 132 is peripherally connected to computer system 100, etc.). Further, the devices shown and described in FIG. 1 may each include hardware and/or software device drivers, interfaces, registers, buffers, or the like to allow for effective communication between devices.

The computer system shown in FIG. 1 is intended to be a simplified representation, it being understood that many variations in system configuration are possible in addition to those specifically mentioned here. For instance, though computer system 100 may be a portable device as described above, computer system 100 may also be a larger computer system such as a general purpose server.

Various embodiments of the present invention pertain to methods that may be implemented upon or by computer system 100. When computer system 100 performs particular tasks according to one or more methods described herein as is directed by at least one application 124, such computer system 100 becomes a special purpose computer particular to those one or more methods.

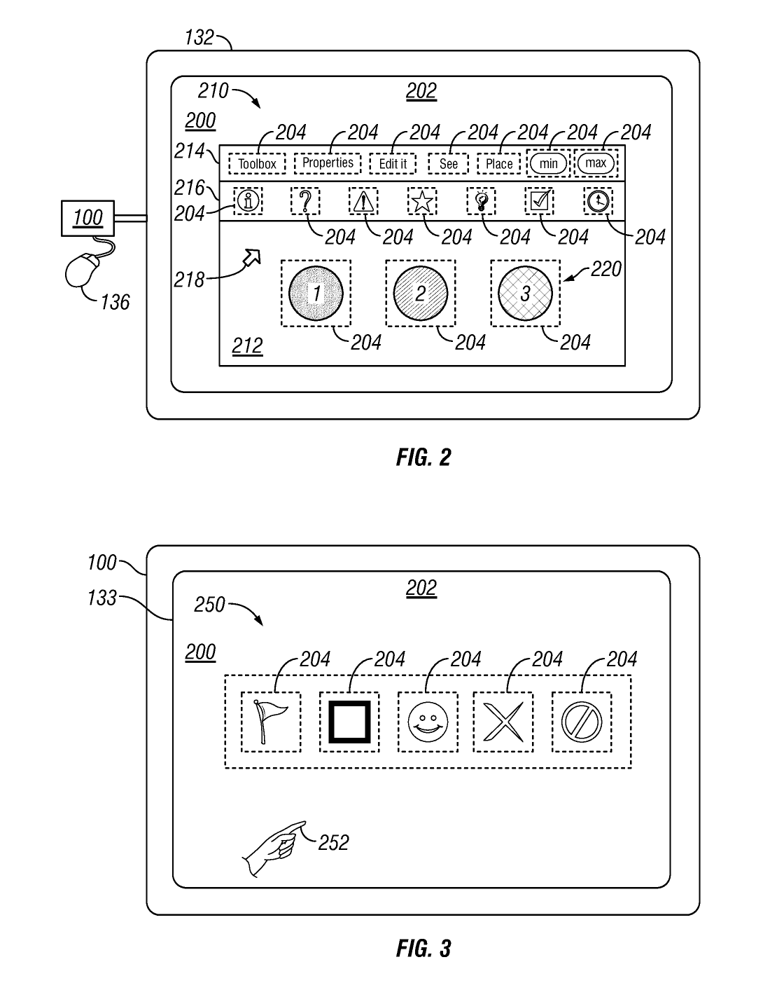

FIG. 2 and FIG. 3 illustrate exemplary GUIs 200 according to various embodiments of the present invention. GUI 200 may be generated by CPU 106 working in conjunction with applications 124 and GPU 172 as described above. GUI 200 provides a platform 202 that is displayed upon, for example, display 132, touch screen display 133, etc. In various embodiments, the user may interact with platform 202 to manage computer system 100, to manage one or more devices in computer system 100, to manage or control one or more applications 124, and/or to manage one or more devices connected to computer system 100, etc. It is to be understood that platform 202 may be utilized to accomplish many other tasks or be otherwise utilized.

Platform 202 may visually present actions available to the user via an interface; thus enabling user interaction with computer system 100. The user may interact with platform 202 in a variety of ways, but generally the user interacts with platform 202 by manipulating visual objects 204. How a user manipulates a visual object 204 depends upon, for example, the particular visual object 204, hierarchies, associations, or relationships that exist between multiple visual objects 204, rules as defined by an application 124 associated with visual objects 204, etc.

As shown in FIG. 2, platform 202 may present a WIMP interface 210 (window, icon, menu, pointing device) to a user. When using a WIMP interface 210, the user utilizes, for example, the mouse or other handheld device 136 to control the position of cursor 218. In certain embodiments, the WIMP interface 210 presents information in a window 212 and an icon 220 based environment. The user may manipulate a particular visual object 204 by maneuvering cursor 218 to the particular object (e.g. “flyover”, etc.) and/or by engaging the mouse or other handheld device 136 (e.g. click, double click, etc.), etc. More generally, the user may manipulate a particular visual object 204 by otherwise utilizing WIMP interface 210 to engage with the particular visual object 204.

As shown in FIG. 3, platform 202 may present a gesture interface 250 to a user. Using gesture interface 250, the user may interact with computer system 100 by making gestures with one or more fingers 252 in contact with touch screen display 133. Exemplary gestures are pointing, pinching, flicking, rotating, etc. More generally, the user may manipulate a particular visual object 204 by otherwise utilizing gesture interface 250 to engage with the particular visual object 204. Gesture interface 250 is beneficial when computer system 100 is a smaller mobile device such as a tablet, PDA, or smart phone, due to constraints in space.

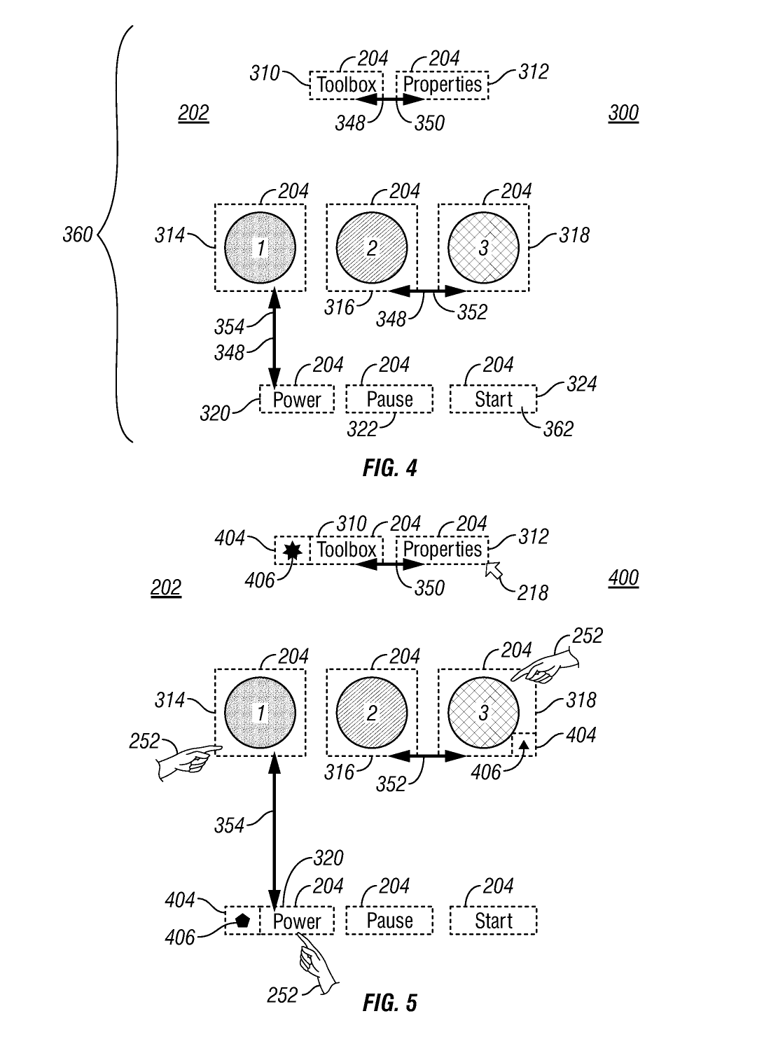

FIG. 4 illustrates associations 348 between various graphic objects 202 according to various embodiments of the present invention. As indicated above, the user may interact with platform 202 by manipulating visual objects 204. However, the user may manipulate the visual objects 204 only as is governed by various hierarchies, rules, policies imposed upon all visual objects, upon groups of particular visual objects, upon a single visual object, or relationship rules that are imposed between multiple visual objects 204. More generally, these hierarchies, rules, or relationships are referred herein to as associations 348. Therefore the user may manipulate visual objects 204 as is allowed or otherwise governed by one or more associations 348.

Associations 348 may be predetermined, preprogrammed, or otherwise integrated into an application 124. Therefore, CPU 106 and GPU 172 work in conjunction as directed by application 124 to manipulate pixels on external display 132 or touch screen 133 to create the image according to, at least in part, associations 348. For example, an association 348 may indicate that a particular graphic object 202 may never be manipulated by a user. This association 348 is integrated into application 124 and when application 124 is executed by computer system 100, the particular graphic object 202 that is displayed upon touch screen 133 is unable to be manipulated by the user. It is to be understood that though only three associations 348 are shown in FIG. 4, there may many associations 348 relevant to a particular GUI.

FIG. 4 also depicts an exemplary GUI 300. GUI 300 provides platform 202 that is displayed upon, for example, display 132, touch screen display 133, etc. GUI 300 includes a graphic objects 310, 312, 314, 316, 318, 320, 322, and graphic object 324.

As indicated above, many associations 348 may be relevant to a particular GUI. For example, association 350 governs the relationship between visual object 310 and visual object 312, association 352 governs the relationship between graphic object 316 and graphic object 318, and association 354 governs the relationship between graphic object 312 and graphic object 320. In some embodiments, a single graphic object 204 may be governed by multiple associations 348. In various embodiments, a global association 360 may govern all graphic objects 204 and/or a solo association 362 may govern a single graphic object 204.

Association 350 may indicate that visual object 310 must first be manipulated prior to a user manipulating visual object 312. Association 352 may indicate that visual object 316 must be manipulated prior to the manipulation of visual object 318. Association 354 may indicate that visual object 320 can not be manipulated unless visual object 318 is first manipulated. Association 360 may indicate that only an authenticated user may manipulate graphic objects 204. Association 362 may indicate that visual object 324 may only be manipulated if the user holds a requisite clearance. Though these specific examples of associations are described, it should be known that many other associations may be implemented.

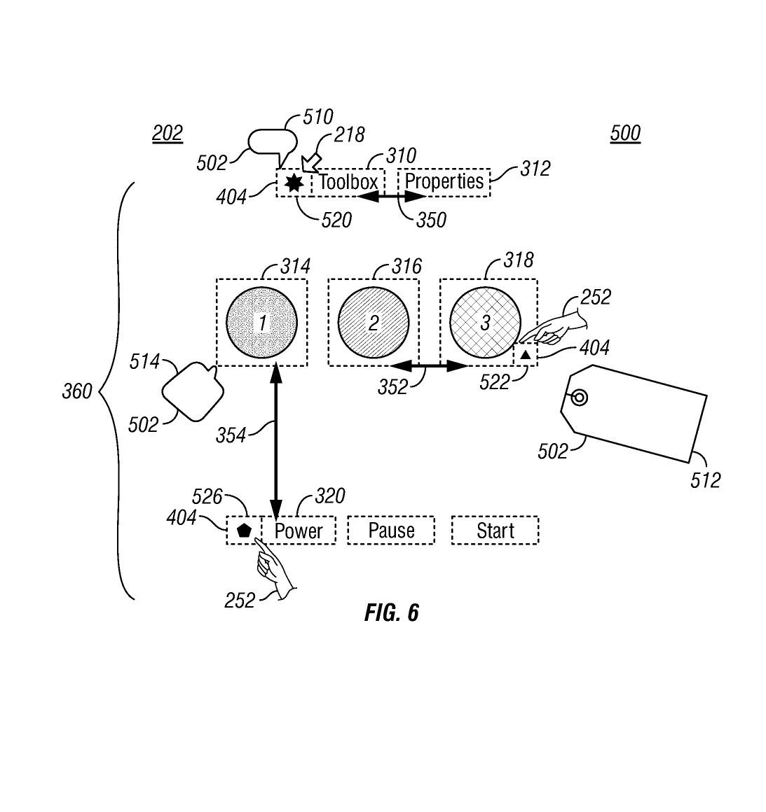

FIG. 5 illustrates a notification graphic object (NGO) 404 being displayed in an exemplary GUI 400 according to various embodiments of the present invention. An NGO 404 may alert the user that details relevant to an association 348 are otherwise available to be displayed. The user may ultimately manipulate NGO 404 in order to display those details relevant to the association 348.

An NGO 404 may be displayed to alert the user that he or she has failed to comply with an association 348 (e.g. NGO 404 is shaded red thus indicating an error, etc.). An NGO 404 may be displayed to alert the user of compliance with association 348 (e.g. NGO 404 is shaded green thus indicating compliance, etc.). NGO 404 may be displayed to alert the user that directions to comply with an association 348 are otherwise available to be displayed (e.g. NGO is a “?” icon, etc.). More generally, an NGO 404 may be displayed to alert the user that useful information regarding an association 348 is otherwise available to be displayed.

An NGO 404 may be displayed in connection with a graphic object 204. For example, in certain embodiments, an NGO 404 may be displayed adjacent to a graphic object 204 (i.e. NGO 404 and graphic object 204 are adjacent but distinct) and in other embodiments an NGO 404 may be integrated with a graphic object 204 (i.e. the combination of NGO 404 and the graphic object 204 are integrated into one single graphic object).

In various embodiments NGO 404 may include or take the shape of an icon 406. Computer system 100 may utilize a library (i.e. various) of icons 406 when displaying a particular GUI. The particular icon 406 that is displayed may be chosen based in part on the relevance of the icon 406 to a particular association 348. For example, if an association 348 governs graphic objects 204 utilized by the user to power up/down the computer system 100, a “power up” or “power down” icon 406 may be displayed, respectively. In other words, the icon 406 may be indicative to a particular association 348. Therefore in certain embodiments differing NGOs 404 may include differing icons 406. However, in other embodiments, the NGOs 404 may include similar icons 406.

In certain embodiments NGO 404 is generated and displayed upon the manipulation of a first graphic object 204. For example, after the user manipulates a first graphic object 204, the various associations 348 relevant to the first graphic object 204 are determined. The NGOs 404 that should be displayed are determined. Finally the particular one or more NGOs 404 may be displayed in connection with the first graphic object 204.

For example, as depicted in FIG. 5, the user may manipulate graphic object 318 being displayed, for example upon a touch screen 133, with one or more fingers 252. It may then be determined what associations are relevant to graphic object 318. Association 352 is relevant to graphic object 318 though many other associations 348 may be relevant. Once it has been determined that association 352 relevant to graphic object 318, the NGO 404 that should be displayed is determined. Finally, NGO 404 is displayed in connection with graphic object 318.

Rather than displaying NGO 404 in connection with the graphic object 204 that was first manipulated by the user, the NGO 404 may be displayed in connection with a different graphic object 204. For example, the user may manipulate graphic object 312 with cursor 218. What associations 348 are related to graphic object 312 may then be determined. As depicted in FIG. 5, association 350 is relevant to graphic object 312 (note that association 350 is also relevant to graphic object 310). What NGO 404 should be displayed may then be determined. However, instead of displaying NGO 404 in connection with graphic object 312, NGO 404 may be displayed in connection with graphic object 310.

In certain embodiments NGO 404 is generated and displayed upon the manipulation of a first graphic object 204 and the manipulation of a second graphic object 204. For example, the user may manipulate a first graphic object 204 and a second graphic object 204. The associations 348 relevant to both the first graphic object 204 and the second graphic object 204 are determined. What NGOs 404 should be displayed may be determined. In other words, the relevant associations 348 are determined subsequent to the manipulation of a first graphic object 204 and the manipulation of a second graphic object 204. Finally the particular one or more NGOs 404 may be displayed.

For example, as depicted in FIG. 5, the user may first manipulate graphic object 314 with one or more fingers 252. The user may then manipulate graphic object 320 with one or more fingers 252. It may then be determined what associations 348 are related to both graphic object 314 and graphic object 320. Association 354 is relevant to both graphic object 314 and graphic object 320. What NGO 404 should be displayed may then be determined. NGO 404 may then be displayed in connection with graphic object 314 or with graphic object 320.

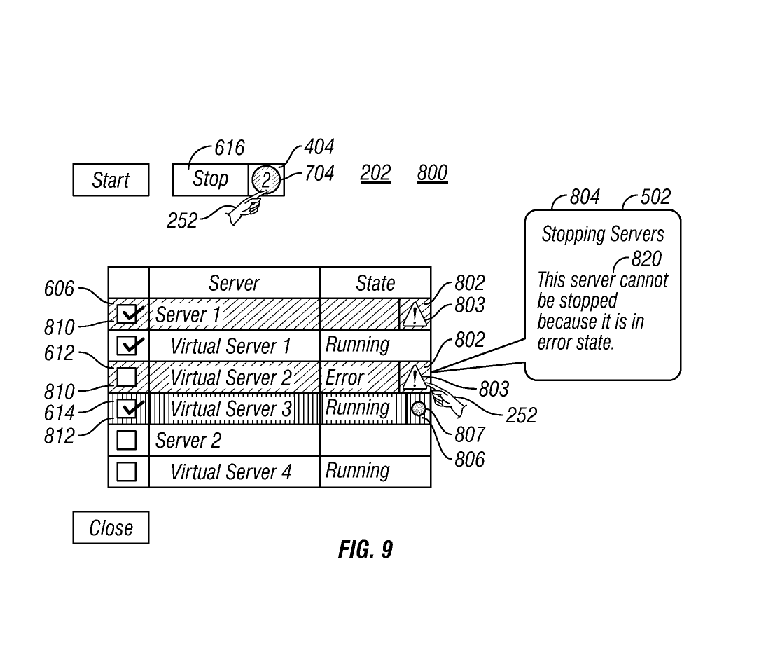

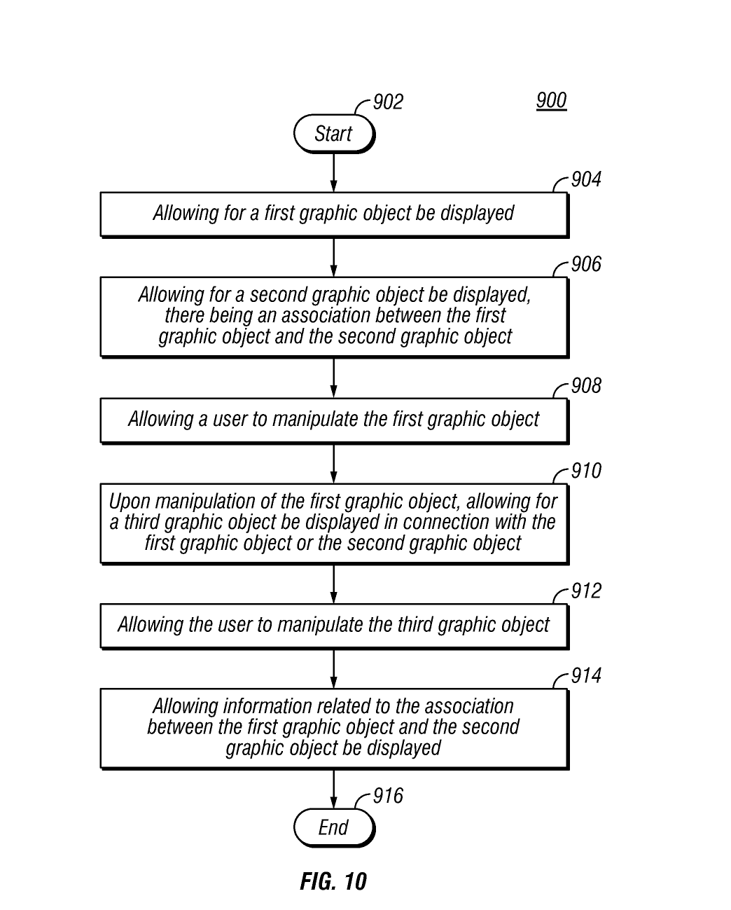

In various embodiments, NGO 404 is displayed prior to the user taking an action manipulation. An action manipulation is a manipulation by the user to engage, disengage, start, end, commence, etc. an action, task, job, event. An action manipulation typically occurs after a user makes a select manipulation of one or more graphic objects 204, but may occur at other instances depending upon particular graphic object(s) 204. A select manipulation is a manipulation made by a user to select or otherwise highlight a particular one or more graphic object(s) 204. For example, an NGO 404 may be displayed to alert the user of potentially useful information regarding association 352 and is displayed prior to the user manipulating graphic object 320. Manipulating graphic object 320 is an exemplary action manipulation since the user is requesting a power up or a power down action. Other exemplary action manipulations would be the manipulation of graphic object 322 or graphic object 324 in FIG. 5 and the manipulation of graphic object 616 in FIG. 7A. In other embodiments, NGO 404 is displayed after the user takes an action manipulation. For example, NGO 404 is displayed to alert the user of potentially useful information regarding association 354 and is displayed after the user manipulates graphic object 320.

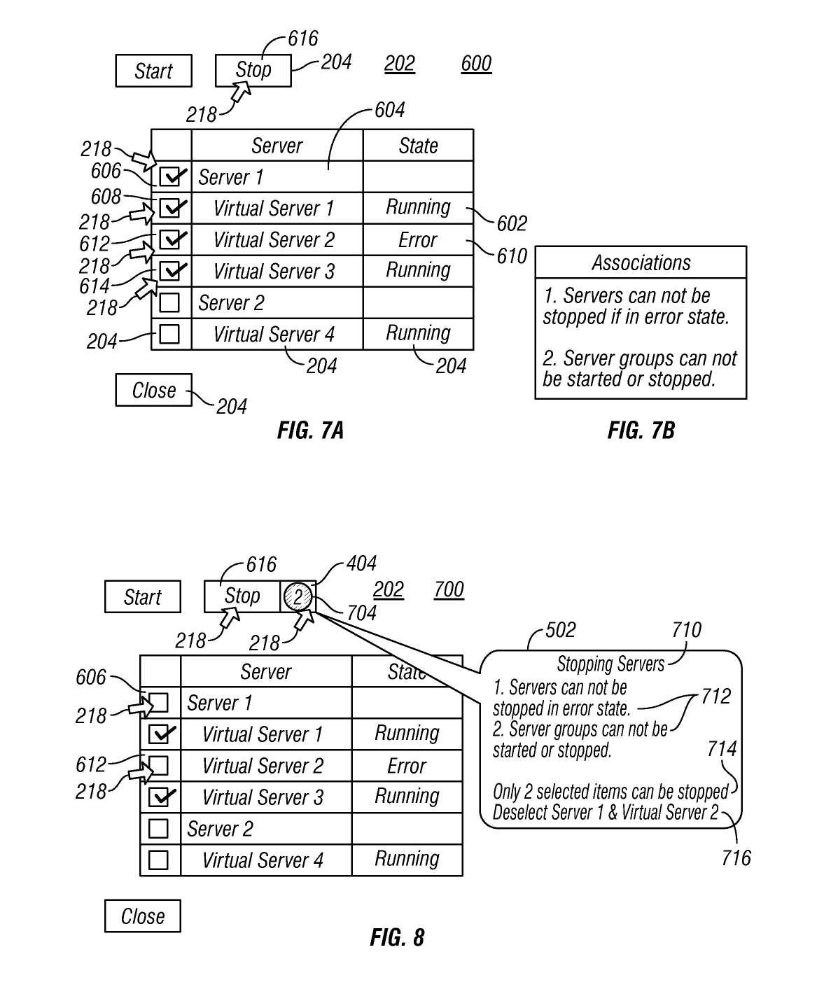

FIG. 6 illustrates an exemplary GUI 500 displaying NGOs 404 and message boxes (MBs) 502, according to embodiments of the present invention. As indicated above, NGOs 404 may also be manipulated by a user. For example, the user may manipulate a particular NGO 404 by maneuvering cursor 218 to the particular NGO 404 (e.g. “flyover”, etc.) and/or by engaging the mouse or other handheld device 136 (e.g. click, double click, etc.), etc. More generally, the user may manipulate the particular NGO 404 by otherwise utilizing WIMP interface 210 to engage with the particular visual object 204. Further, the user may manipulate a particular NGO 404 by performing a gesture upon the particular NGO 404 using one or more fingers 252 in contact with touch screen display 133. More generally, the user may manipulate the particular NGO 404 by otherwise utilizing gesture interface 250 to engage with the particular NGO 404.

Upon the manipulation of an NGO 404, an MB 502 may be displayed. MB 502 may include details, contents, messages, notifications, directions, etc. relevant to an association 348. For example, MB 502 may describe an association 348 to the user (e.g. “icon 2 can not be selected because icon 1 was previously selected”, etc.). MB 502 may notify the user for failing to comply with an association 348 (e.g. “you can not select icon 2 because icon 1 was previously selected”, etc.). MB 502 may display directions to comply with an association 348 (e.g. “unselect icon 1 and reselect icon 2”, etc.). Generally, MB 502 may display to the user otherwise useful information regarding an association 348.

An MB 502 may be displayed in connection with a graphic object 204 or in connection with a NGO 404. For example, in certain embodiments, an MB 502 may be displayed adjacent to a graphic object 204 or adjacent to an NGO 404. In other embodiments, MB 502 need not be displayed in connection with a graphic object 204 or with an NGO 404. For example, the MB 502 may be displayed within the GUI separate from graphic object 204 or NGO 404.

As indicated above, upon the manipulation of an NGO 404, an MB 502 may be displayed. For example, as depicted in FIG. 6, after NGO 520 is manipulated by the user with cursor 218 (i.e. “flyover”, “gesture”, “click”, etc.), MB 510 is displayed in connection with graphic object 310 and/or graphic object 312. Similarly, after NGO 526 is manipulated by the user with one or more fingers 252, MB 514 is displayed in connection with graphic object 314 and/or graphic object 320. Similarly, after NGO 522 is manipulated by the user with one or more fingers 252, MB 512 is displayed in connection with graphic object 316 and/or graphic object 318.

Generally MB 510, MB 514, and/or MB 512 may display contents, messages, notifications, directions, etc. that may be helpful to the user. In certain embodiments MB 512 may display contents, messages, notifications, directions, etc. specifically related to association 352. In still other embodiments, MB 510 or MB 512 may display contents, messages, notifications, directions, etc. related to multiple associations 348 (e.g. association 350, association 352, and/or global association 360).

FIG. 7A illustrates exemplary user manipulations within an exemplary GUI 600, according to various embodiments of the present invention. FIG. 7B illustrates exemplary associations 348 that are relevant to the graphic objects 204 of GUI 600, according to various embodiments of the present invention.

GUI 600 presents a management interface that a user may utilize to control one or more computer systems 100 and/or one or more applications 124 (i.e. servers, virtual servers, etc.). GUI 600 includes graphic objects 602, 604, 606, 608, 610, 612, 614 and 616, but also may include other graphic objects 204.

The user may utilize GUI 600 to control one or more computer systems 100 by manipulating graphic objects 204. For example, the user may desire to stop Server 1, Virtual Server 1, Virtual Server 2, and Virtual Server 3. Therefore, the user may manipulate graphic object 606, graphic object 608, graphic object 612, and graphic object 614. Finally, to stop Server 1, Virtual Server 1, Virtual Server 2, and Virtual Server 3, the user may attempt to manipulate graphic object 616.

However, because of associations 348 shown in FIG. 7B that exist between graphic object 606, graphic object 608, graphic object 612, graphic object 614, and graphic object 616, the user is unable to stop Server 1, Virtual Server 1, Virtual Server 2, and Virtual Server 3. In other words, the associations 348 prevent the manipulation of graphic object 616 of being enacted, entered, or otherwise implemented.

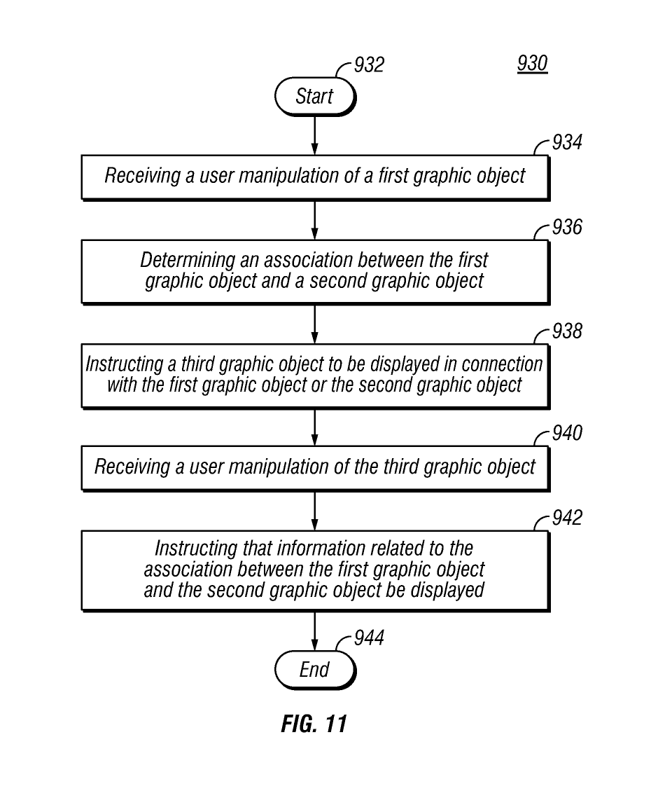

FIG. 8 illustrates exemplary user manipulations within an exemplary GUI 700 that may alert the user that details relevant to an association 348 are otherwise available to be displayed, and that may ultimately display those associations 348, according to various embodiments of the present invention.

The associations 348 of FIG. 8 prevent the manipulation of graphic object 616 of being enacted, entered, or otherwise implemented. However, upon the manipulation of graphic object 616, NGO 404 may be displayed. NGO 404 may include an icon 704 indicating the number of association 348 errors. In this FIG. 8 example, the user has committed two associations 348 errors by manipulating graphic object 606, graphic object 608, graphic object 612, graphic object 614, and graphic object 616. Since two association 348 errors exist, a “2” icon 704 may be utilized.

In various embodiments, MB 502 may be displayed. MB 502 may include a title 710, rule(s) 712, rule(s) summary 714, and/or suggestion(s) 716. In other embodiments, information that is related to the at least one association that governs multiple user manipulated graphic objects is displayed. The information identifies one or more user manipulations that can not be jointly completed for the user manipulated multiple graphic objects. For example, GUI 700 may display the following message: “Virtual Server 2 can not be stopped in error state”, “Server groups can not be started or stopped”, “Server 2 can not be started”, “User can not select Server 1”, etc.

The user may utilize the contents of MB 502 to change, adjust, or otherwise re-manipulate one or more graphic objects 204 to resolve any association 348 errors. For example, the user may manipulate (e.g. unselect, etc.) graphic object 606 and graphic object 612 to resolve the one or more associations 348 errors. Once the user has resolved the association 348 errors, the user is free to manipulate graphic object 616 to stop Virtual Server 1 and Virtual Server 3. Upon the selection of graphic object 616, Virtual Server 1 and Virtual Server 3 may now in fact be stopped.

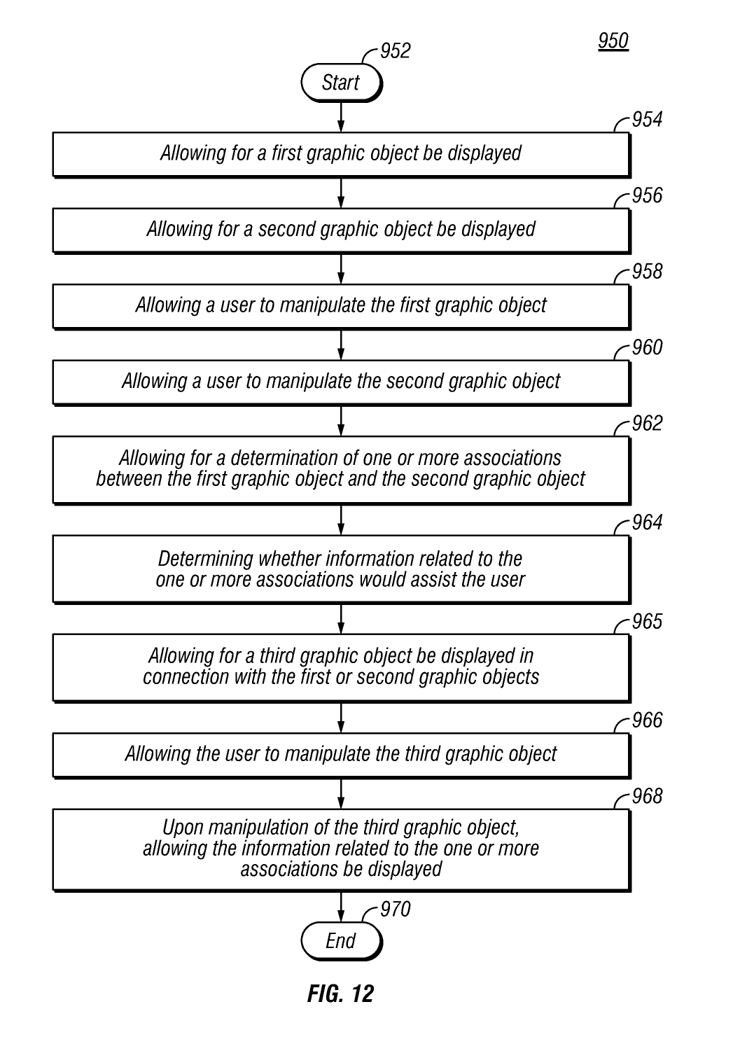

FIG. 9 illustrates exemplary user manipulations within an exemplary GUI 800 that may display associations 348 and other visual indications, according to various embodiments of the present invention. Upon the manipulation of graphic object 616, NGO 404 may be displayed. As stated above, NGO 404 may then also be manipulated (e.g. by one or more fingers 252, etc.). However, instead of displaying a MB 502, one or more other NGOs 404 may be displayed. For example, when the user manipulates NGO 404 with one or more fingers 252, NGO 802 and/or NGO 806 may be displayed.

NGO 802 and/or NGO 806 may be displayed to alert the user that an association 348 and/or MB 502 is otherwise available to be displayed, to alert the user to an association 348, to alert the user for failing to comply with an association 348, to alert the user there are no association 348 errors, to alter the user to directions to comply with an association 348, etc. Generally, NGO 802 and/or NGO 806 may be displayed to alert the user that useful information regarding an association 348 is otherwise available to be displayed.

NGO 802 and/or NGO 806 may be displayed in connection with a graphic object 204 and/or an NGO 404. For example, in certain embodiments, NGO 802 and/or NGO 806 may be displayed adjacent to a graphic object 204 and/or NGO 404. In other embodiments NGO 802 and/or NGO 806 may be integrated with a graphic object 204 and/or another NGO 404.

NGO 802 includes a “caution” icon 803 that alerts the user of an association 348 error. NGO 806 includes a “go” icon 807 that alerts the user of being in compliance with associations 348. In this manner, icon 803 and icon 807 may be indicative to a particular association 348 error or indicative of compliance with a particular association 348.

The user may manipulate NGO 802 or NGO 806 and MB 804 may be displayed. MB 804 may be displayed in connection with NGO 802, NGO 806, or with another graphic object 204. MB 804 may display helpful information related specifically to NGO 802 or NGO 806 to the user. In certain embodiments MB 804 may display information related to association 352 and related to NGO 802/NGO 806. In certain embodiments, MB 804 may include a statement related specifically to NGO 802, NGO 806, or an otherwise connected graphic object 204 respectively. For example, MB 804 may include a statement 820 relating to specifically to NGO 802/graphic object 612.

GUI 800 also illustrates other visual indications that may be displayed. Upon the manipulation of graphic object 616, visual indication 810 and/or visual indication 812 may be displayed. Visual indication 810 is shading, hewing, or other highlighting of one or more graphic objects 204 that gives an indication to the user that an association 348 is in error. For example, graphic object 204 may be shaded red if an association 348 error exists. Visual indication 812 is shading, hewing, or other highlighting of one or more graphic objects 204 that gives an indication to the user that no association 348 errors exist. For example, graphic object 204 may be shaded green if no association 348 errors exist.

In some embodiments, automatic correction of association 348 errors may occur upon the manipulation of NGO 404 or NGO 802. For example, an association 348 error occurs when the user manipulates or selects graphic object 612 in combination with graphic object 616. NGO 404 is then displayed. Upon the manipulation of NGO 404, application 124/CPU 106/GPU 176 automatically removes, unselects, or otherwise reverses the manipulation of graphic object 816 in order to comply with association 348. For example, upon the manipulation of GNO 404 or GNO 802, graphic object 612 is automatically unselected.

As is described above with reference to one or more embodiments, GUI 800 may communicate status information to a user regarding an action or actions performed on one or more graphic objects. First, the user is able to select one or more graphic objects by making a selection manipulation. The user is then able to select an action to be performed on the selected object or objects by making an action manipulation. Information regarding the suitability of the action manipulation may be displayed. The information may be displayed in a flyover, in MB 502, etc. Exemplary information may indicate the applicability of the action manipulation with regards to the selected graphic objects, the number of selected graphic objects the action manipulation applies to, the particular graphic objects the action manipulation applies to, etc. After the user makes the action manipulation, a graphic object may be displayed that shows the outcome of the action manipulation. One or more of the selected graphic objects may change colors, depending upon the outcome of the action manipulation. Information regarding the outcome of the action manipulation may be displayed. Finally, upon the user taking a next action, the GUI is cleared. For example, the color of a graphic object reverts to the original color, the one or more fly over messages are cleared, etc.

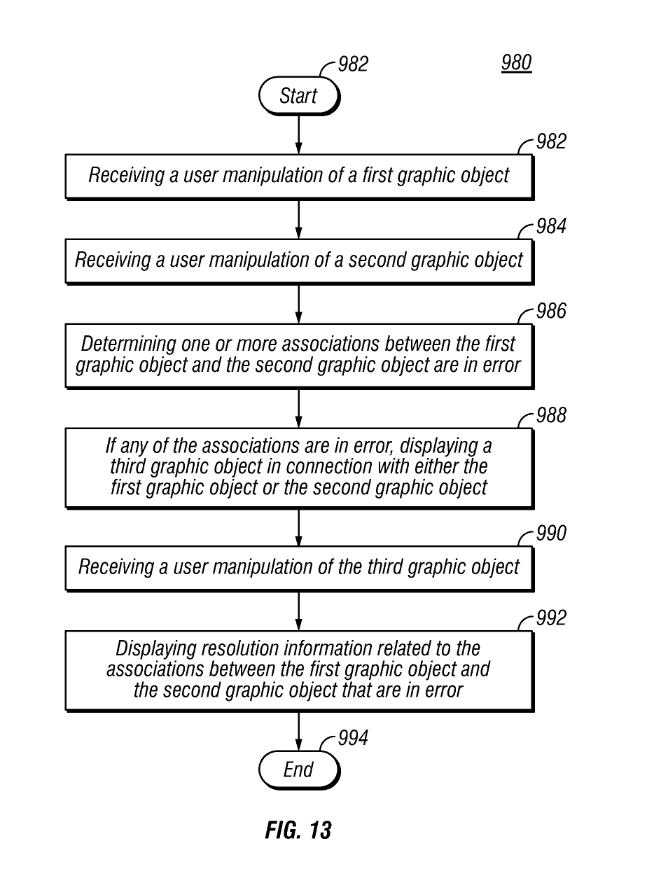

FIG. 10 illustrates an exemplary method 900. Method 900 starts at block 902 and may be utilized, for example, by an entity allowing (e.g. utilizing, designing, enabling, installing, contributing to, etc.) an application 124 to engage in one or more method steps described herein. Method 900 continues by allowing a first graphic object 204 be displayed (block 904) in a GUI of a computer system or such information handling device Likewise, a second graphic object 204 is allowed to be displayed (block 906). An association 348 exists between the first graphic object 204 and the second graphic object 204 (block 906).

The user is allowed to manipulate the first graphic object 204 (block 908). For example, the computer system receives a user manipulation of the first graphic object 204, using one or more fingers 252 or cursor 218, with a user manipulation receiver as discussed herein. Upon the manipulation of the first graphic object 204, a third graphic object 204 (e.g. an NGO 404) is allowed to be displayed in connection with the first graphic object 204 or in connection with the second graphic object 204 (block 910).

The user is allowed to manipulate the third graphic object 204 (e.g. an NGO 404) (block 912). Upon the manipulation of the third graphic object, information related to the association 348 between the first graphic object 204 and the second graphic object 204 is allowed to be displayed (block 914). For example, an MB 502 is displayed. Method 900 ends at block 916.

FIG. 11 illustrates an exemplary method 930. Method 930 starts at block 932 and may be practiced, for example, by an entity that develops, sells, etc. an application 124 or a computer system 100 that engages in one or more method steps described herein. Method 930 continues by receiving a user manipulation of a first graphic object 204 (block 934). For example, the user manipulation receiver of the computer system 100 receives a particular user manipulation. Any associations 348 that exist between the first graphic object 204 and a second graphic object 204 are determined (block 936).

A third graphic object 204 (e.g. an NGO 404) is instructed to be displayed in connection with the first graphic object 204 or in connection with the second graphic object 204 (block 938). A user manipulation of the third graphic object 204 is received (block 940) and information related to the association between the first graphic object 204 and the second graphic object 204 is displayed and/or is instructed to be displayed (block 942). Finally, method 930 ends at block 944.

FIG. 12 illustrates an exemplary method 950. Method 950 starts at block 952 and may be practiced, for example, by an entity allowing (e.g. utilizing, designing, enabling, installing, contributing to, etc.) application 124 to engage in one or more method steps described herein. Method 950 continues by allowing a first graphic object 204 be displayed (block 954) and by allowing a second graphic object 204 be displayed (block 956).

The user is allowed to manipulate the first graphic object (block 958) and is allowed to manipulate the second graphic object (block 960). A determination of one or more associations 348 between the first graphic object 204 and the second graphic object 204 is allowed (block 962). For example, a determination is allowed that identifies associations 348 exist between the two graphic objects 204. It may then be determined if information related to the associations 348 between the first graphic object 204 and the second graphic object 204 may assist the user (block 964).

If information related to the associations 348 would assist the user, a third graphic object (e.g. an NGO 404) is allowed to be displayed (block 965) and the user is allowed to manipulate the third graphic object (block 966). Upon the manipulation of the third graphic object, the information related to associations 348 are allowed to be displayed (block 968). Finally, method 950 ends at block 970.

FIG. 13 illustrates an exemplary method 980. Method 980 starts at block 982 and may be practiced, for example, by an entity developing, creating, selling, etc. an application 124 or a computer system 100 that engages in one or more method steps described herein. Method 980 continues when a user manipulation of a first graphic object is received (block 982). Likewise, a user manipulation of a second graphic object is also received (block 984). For example, the user manipulation receiver of the computer system 100 receives a particular user manipulation.

The one or more associations 348 that exist between the first graphic object 204 and the second graphic object 204 are determined (block 986). It is determined whether the associations 348 that exist between the first graphic object 204 and the second graphic object 204 are in error, not in compliance, etc. (block 986). If any of the associations 248 are in error, a third graphic object 204 is displayed in connection with the first graphic object 204 or in connection with the second graphic object 204 (block 988).

Method 980 continues when a user manipulation of the third graphic object is received (block 990) and error resolution information related to the associations 348 that are in error is displayed (block 992). Method 980 ends at block 994.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over those found in the marketplace, or to enable others of ordinary skill in the art to understand the embodiments disclosed herein.

What is claimed is:

1. A method of providing a graphic user interface (GUI) comprising:
(1) allowing a first graphic object and a second graphic object be displayed within a GUI of an computer system, there being at least one association governing both the first graphic object and the second graphic object;
(2) upon receiving a user manipulation of the first graphic object, with the computer system, allowing a third graphic object be displayed within the GUI of the computer system, the third graphic object being displayed in connection with the first graphic object or the second graphic object;
(3) allowing information related to the at least one association governing both the first graphic object and the second graphic object be displayed within the GUI of the computer system in connection with the third graphic object.

2. The method of claim 1 wherein the information related to the at least one association governing both the first graphic object and the second graphic object is displayed within the GUI of the computer system prior to the computer system receiving an action manipulation.

3. The method of claim 1 wherein the third graphic object is allowed to be displayed within the GUI of the computer system subsequent to receiving a user manipulation of the second graphic object.

4. The method of claim 3 further comprising:
(1) upon receiving the user manipulation of the first graphic object and the user manipulation of the second graphic object, determining with the computer system the one or more associations governing both the first graphic object and the second graphic object.

5. The method of claim 1 wherein information related to the at least one association governing both the first graphic object and the second graphic object is displayed within a message box in the GUI of the computer system.

6. The method of claim 2 wherein the third graphic object is a notification graphic object comprising an icon indicative of the at least one association governing both the first graphic object and the second graphic object.

7. The method of claim 1 wherein the information related to the at least one association governing both the first graphic object and the second graphic object identifies one or more user manipulations that can not be jointly completed for the first graphic object and for the second graphic object.

8. A computer program product for providing a graphic user interface (GUI), said computer program product comprising:
(1) a computer readable storage medium;
(2) first program instructions to allow, using a processor, a first graphic object and a second graphic object be displayed within a GUI, there being at least one association governing both the first graphic object and the second graphic object;
(3) second program instructions to allow, using a processor, a third graphic object be displayed within the GUI upon receiving a user manipulation of the first graphic object, the third graphic object being displayed in connection with the first graphic object or the second graphic object;
(4) third program instructions to allow, using a processor, information related to the at least one association governing both the first graphic object and the second graphic object be displayed within the GUI;
(5) and wherein the first, second, and third program instructions are stored on the computer readable storage medium.

9. The computer program product of claim 8 wherein the information related to the at least one association governing both the first graphic object and the second graphic object is displayed within the GUI prior to receiving an action manipulation.

10. The computer program product of claim 8 wherein the second program instructions allow the third graphic object be displayed within the GUI subsequent to also receiving a user manipulation of the second graphic object.

11. The computer program product of claim 8 further comprising:
(1) fourth program instructions for determining, using a processor, the at least one association governing both the first graphic object and the second graphic object, upon receiving the user manipulation of the first graphic object and the user manipulation of the second graphic object;
(2) and wherein the fourth program instructions are stored on the computer readable storage medium.

12. The computer program product of claim 8 wherein the third program instructions allow the at least one association governing both the first graphic object and the second graphic object be displayed within a message box.

13. The computer program product of claim 9 wherein the third graphic object is a notification graphic object comprising an icon indicative of the at least one association governing both the first graphic object and the second graphic object.

14. The computer program product of claim 8 wherein the information related to the at least one association governing both the first graphic object and the second graphic object identifies one or more user manipulations that can not be jointly completed for the first graphic object and for the second graphic object.

15. A computer system comprising:
(1) a display device;
(2) a graphic object manipulation receiver;
(3) a processor programmed to provide a graphic user interface (GUI) upon the display device;
(a) wherein the GUI is operative to at least:
allow a first graphic object and a second graphic object be displayed upon the display device, there being at least one association governing both the first graphic object and the second graphic object;
allow a third graphic object be displayed upon the display device, upon the receipt of a user manipulation of the first graphic object via the graphic object manipulation receiver;
allow information related to the at least one association governing both the first graphic object and the second graphic object be displayed upon the display device.

16. The computer system of claim 15 wherein the information related to the at least one association governing both the first graphic object and the second graphic object is displayed within the GUI prior to the processor receiving an action manipulation command from the graphic object manipulation receiver.

17. The computer system of claim 15 wherein the GUI is further operative to allow the third graphic object be displayed upon the display device subsequent to also receiving a user manipulation of the second graphic object via the graphic object manipulation receiver.

18. The computer system of claim 17 wherein upon the receipt of a user manipulation of the first graphic object via the graphic object manipulation receiver and upon the receipt of a user manipulation of the second graphic object via the graphic object manipulation receiver, the processor is further programmed to determine the at least one association governing both the first graphic object and the second graphic object.

19. The computer system of claim 15 wherein the at least one association governing both the first graphic object and the second graphic object is displayed within a message box.

20. The computer system of claim of claim 16 wherein the third graphic object is a notification graphic object comprising an icon indicative of the at least one association governing both the first graphic object and the second graphic object.
